(19) United States
(12) Patent Application Publication
(10) Pub. No.: US 2007/0287502 A1
(43) Pub. Date: Dec. 13, 2007

(54) Antenna assembly

(75) Inventors: Sheng-Hsiung Yang, Hukou Township (TW); Teng-Chao Chiang, Hsinchu (TW)

Correspondence Address: RABIN & Berdo, PC, 1101 14TH STREET, NW, SUITE 500, WASHINGTON, DC, 20005, US

(73) Assignee: SmartAnt Telecom Co., Ltd., Hsinchu County (TW)

(21) Appl. No.: 11/808,328

(22) Filed: Jun. 8, 2007

(30) Foreign Application Priority Data
Jun. 9, 2006 (TW) 095210171

(51) Int. Cl. H04B 7/185; H04M 1/00

(52) U.S. Cl. 455/562.1; 455/575.7; 455/13.3

(57) ABSTRACT

An antenna assembly includes a plurality of wireless signal transceivers and at least one positioning plate. Each of the wireless signal transceivers includes a base fixed on the positioning plate. The positioning plate has an expansion capability for a plurality of bases being fixed thereon, such that a user can add or reduce the number of the wireless signal transceiver independently.

### CROSS-REFERENCE TO RELATED APPLICATIONS

This non-provisional application claims priority under 35 U.S.C. § 119(a) on Patent Application No(s). 095210171 filed in Taiwan, R.O.C. on Jun. 9, 2006, the entire contents of which are hereby incorporated by reference.

### BACKGROUND OF THE INVENTION

1. Field of Invention

The present invention relates to an antenna assembly, and more particularly to an antenna assembly that has an expansion capability and is fixed on a support interface.

2. Related Art

With the rapid development of electronic science and technology, desktop or laptop computers have powerful operating functions, and are widely used by companies, enterprises, and consumers. In order to link the computers effectively to transmit or exchange various information and data, many enterprises chose to use signal cables and servers to construct required internal networks.

However, the cost for designing and practically wiring wired networks is quite high, the construction of the wired networks and the wiring will cause damages to the buildings, and complicated connections are disadvantageous to management and maintenance. Therefore, many enterprises turn to use wireless networks to construct the required internal networks.

In order to perform the wireless signal transmission, antenna equipment must be set up at specific positions. According to different places where the antennae are used, they are further classified into indoor antennae and outdoor antennae. An indoor antenna often includes a dedicated stand to support the antenna, and is placed on a desk or hung on a wall, e.g., an example of the indoor antenna disclosed in Taiwan Patent Publication No. M243796. An outdoor antenna is fixed to a round column or a wall with a support base, e.g., a structural design of a base for fixing an antenna disclosed in Taiwan Patent Publication No. 241952.

Moreover, U.S. Pat. No. 6,232,928 provides an antenna fixing member that can be fixed to a round column. The antenna fixing member uses a clamp to fix one end of two support brackets to the round column, and the other end of the two support brackets is connected to an antenna. The support brackets can adjust the relative angle between the antenna and the round column.

Moreover, in these environments, the wireless signals are often transmitted on various paths or in different spatial dimensions to form a plurality of series flows. In an indoor environment, the obtained capacity increases linearly with the increase of the number of the antennae. Therefore, in order to meet the requirements of increasing the number of the antennae, the antenna supporting or fixing structures must be capable of fixing a plurality of antennae accordingly.

However, the supporting or fixing structures described above for attaching and positioning an antenna on the desk, wall, or column tube use many components complicated in structure, and can only fix a single antenna. Thus, the manufacturing cost is high, and the assembling and arrangement is difficult, and the signal transmission capacity and signal transmitting and receiving intensity cannot be improved by using more antennae.

### SUMMARY OF THE INVENTION

The antenna assemblies described above can fix only a single antenna, but limit the function of increasing or reducing the number of antennae, so the signal transmission capacity cannot be expanded to be adapted to different communication specifications. In view of the above problems, the present invention is directed to providing an antenna assembly with a plurality of wireless signal transceivers, such that a user can adjust the number of the wireless signal transceivers independently to improve transmission quality of wireless signals.

In order to achieve the aforementioned objective, the present invention provides an antenna assembly, which includes a plurality of wireless signal transceivers and at least one positioning plate. Each of the wireless signal transceivers includes a base and a transmitting and receiving portion disposed on the base. The positioning plate is used for connecting the wireless signal transceivers. The bases are fixed to the positioning plate, so as to combine the plurality of wireless signal transceivers into an antenna assembly. The combination of the plurality of wireless signal transceivers enhances a transmitting and receiving intensity of wireless signals or increases a transmission bandwidth.

In order to achieve the aforementioned objective, the present invention is further directed to providing an antenna assembly, which includes a plurality of wireless signal transceivers. Each of the wireless signal transceivers has a base and a transmitting and receiving portion disposed on the base. Each of the bases has a first engaging portion and a second engaging portion matching with each other, so as to connect the bases, and combine the plurality of wireless signal transceivers into the antenna assembly. The combination of the plurality of wireless signal transceivers enhances the transmitting and receiving intensity of wireless signals or increases the transmission bandwidth.

The advantage of the present invention lies in that the antenna assembly is formed with a plurality of wireless signal transceivers, and can realize the transmission of the wireless signals. Thus, the present invention has the expansion capability by increasing the number of the wireless signal transceivers, so as to increase the transmission capacity of the wireless signals. Furthermore, the wireless signal transceivers can be arranged flexibly to meet the requirements of different communication specifications. Moreover, for new communication specifications in the future, the design of the wireless signal transceivers needs not to be varied significantly. In addition, the complexity of the supporting or fixing structure is reduced as the present invention does not use too many components, and the user can add or remove the wireless signal transceivers through simple fixing means.

Detailed features and advantages of the present invention are described in the embodiments below, and their content is adequate for those skilled in the art to understand the technical content of the present invention and to implement the present invention. According to the content disclosed in the specification, the claims, and the drawings, those skilled in the art can easily understand the objects and advantages of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1A is an exploded structural view of the first embodiment;

FIG. 1B is a combined structural view of the first embodiment;

FIG. 2 is an exploded structural view of the second embodiment;

FIG. 3A is an exploded structural view of the third embodiment;

FIG. 3B is a combined structural view of the third embodiment;

FIG. 4 is a perspective appearance view of the fourth embodiment; and

FIG. 5 is a perspective appearance view of the fifth embodiment.

### DETAILED DESCRIPTION OF THE INVENTION

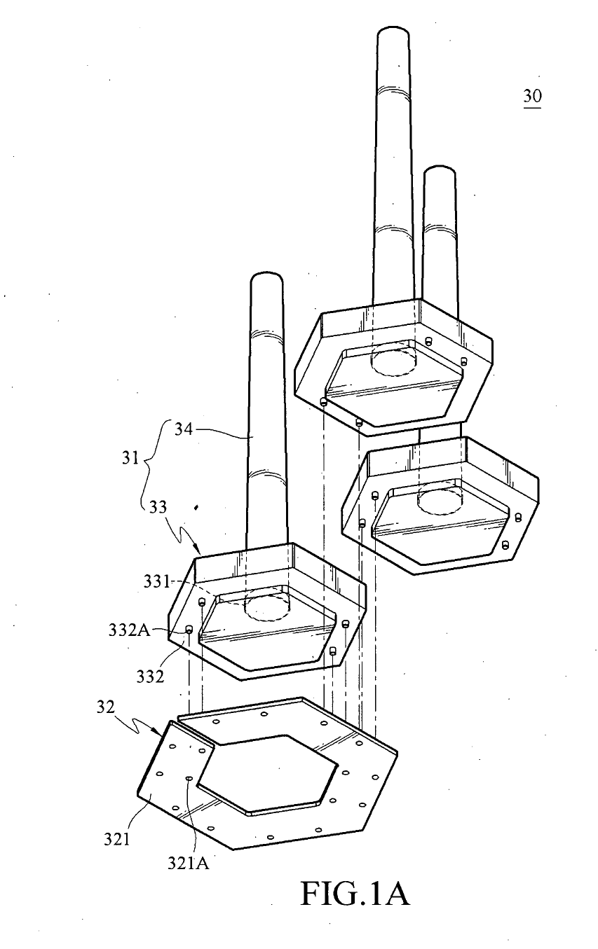

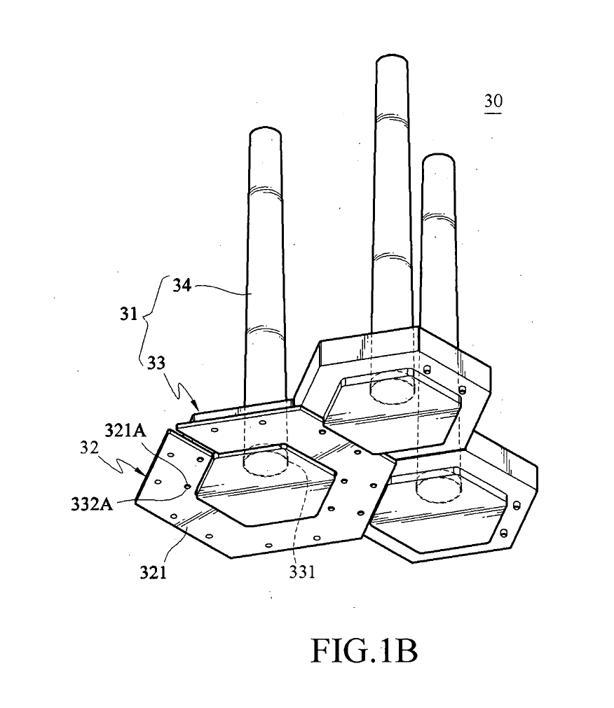

Referring to FIGS. 1A and 1B, an antenna assembly 30 according to a first embodiment of the present invention is shown, which includes a plurality of wireless signal transceivers 31 and at least one positioning plate 32. The number of the wireless signal transceivers' 31 is determined according to actual requirements. Each of the wireless signal transceivers 31 has a base 33 and a transmitting and receiving portion 34 disposed on the base 33, and each base 33 is fixed to the positioning plate 32. The transmitting and receiving portions 34 are used to transmit or receive wireless signals, such that the wireless signal transceivers 31 function normally in corresponding frequency ranges. Each of the bases 33 has a fixing hole 331 formed on a side surface thereof. One end of the transmitting and receiving portion 34 is screwed or inserted into the fixing hole 331. The base 33 and the transmitting and receiving portion 34 can also be formed monolithically, or the transmitting and receiving portion 34 is disposed inside the base 33. The other side of each of the bases 33 has a fixing portion 332, and the positioning plate 32 has a positioning portion 321 corresponding to the fixing portion 332. The fixing portion 332 includes a plurality of positioning posts 332A, and the positioning portion 321 has a plurality of corresponding positioning holes 321A. The positioning posts 332A are inserted into the positioning holes 321A, so as to make fixing portion 332 being coupled to the positioning portion 321, and further to fix the base 33 to positioning plate 32 (as shown in FIG. 7B). Thus, the plurality of wireless signal transceiver 31 is combined into the antenna assembly 30. The combination of the plurality of wireless signal transceiver 31 enhances the intensity of transmitting and receiving the wireless signals, or enables the wireless signal transceivers 31 to work at different frequencies, thereby improving the transmission bandwidth of the entire antenna assembly 30, and increasing the data transmission rate. The transmitting and receiving portions 34 of the wireless signal transceivers 31 are spaced at predetermined distances according to characteristics of the wireless signals, such that the wireless signal transceivers 31 do not interfere with one another in operation.

Referring to FIGS. 1A and 1B again, when the present invention is applied, the fixing portion 332 of the base 33 of each of the wireless signal transceivers 31 is attached towards the positioning portion 321 of the positioning plate 32. The positioning posts 332A of the fixing portion 332 are inserted in the positioning holes 321A, so as to fix the base 33 to the positioning plate 32. Moreover, the projected area of the base 33 is slightly smaller than the area of the positioning plate 32, such that one of the wireless signal transceivers 31 is fixed at the middle of the positioning plate 32. At this time, the positioning plate 32 will protrude relative to an edge of the base 33 of this wireless signal transceiver 31. When it is desired to increase the number of the wireless signal transceivers 31, the wireless signal transceivers 31 are sequentially fixed on the periphery of the positioning plate 32, such that the opposite sides of the bases 33 are abut to one another, thereby realizing the effect of adding the wireless signal transceivers 31 flexibly (as shown in FIG. 1B). The bases 33 are in the shape of a regular polygon, but are not limited to be so.

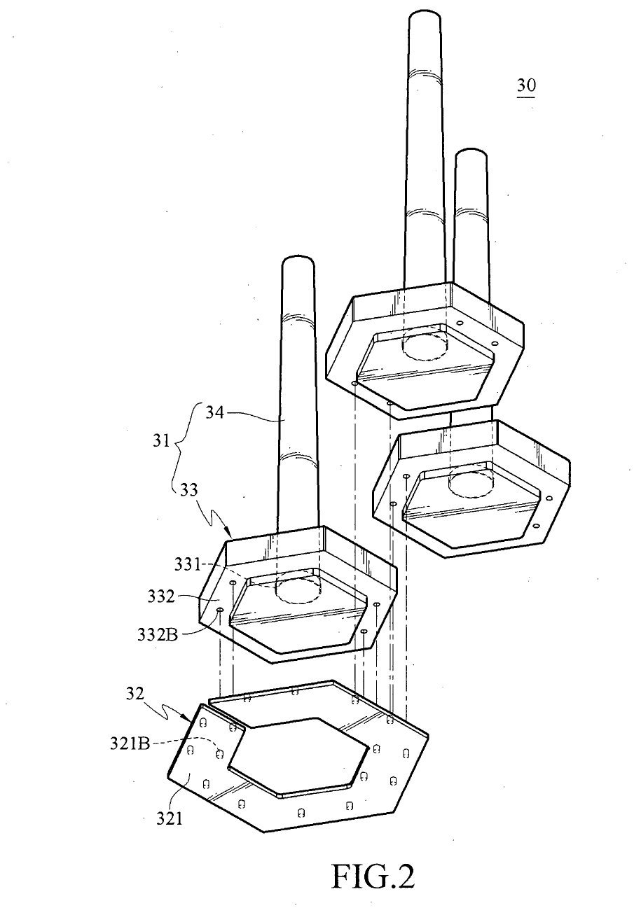

Referring to FIG. 2, an antenna assembly 30 according to a second embodiment of the present invention is shown, which includes a plurality of wireless signal transceivers 31 and at least one positioning plate 32. The overall structure of the second embodiment is similar to that of the first embodiment, while the difference lies in that the fixing portion 332 of each of the bases 33 has a plurality of positioning holes 332B, and the positioning portion 321 of the positioning plate 32 has a plurality of corresponding positioning posts 321B. The positioning posts 321B of the positioning plate 32 engaged in the positioning holes 332B of the base 33, so as to fix the base 33 to the positioning plate 32.

The present invention has disclosed the engagement design of the positioning plate in the first and the second embodiments, while the configuration of the positioning plate naturally is not limited to the engagement. Therefore, a screw design of the configuration of the positioning plate is further disclosed as a third embodiment of the present invention.

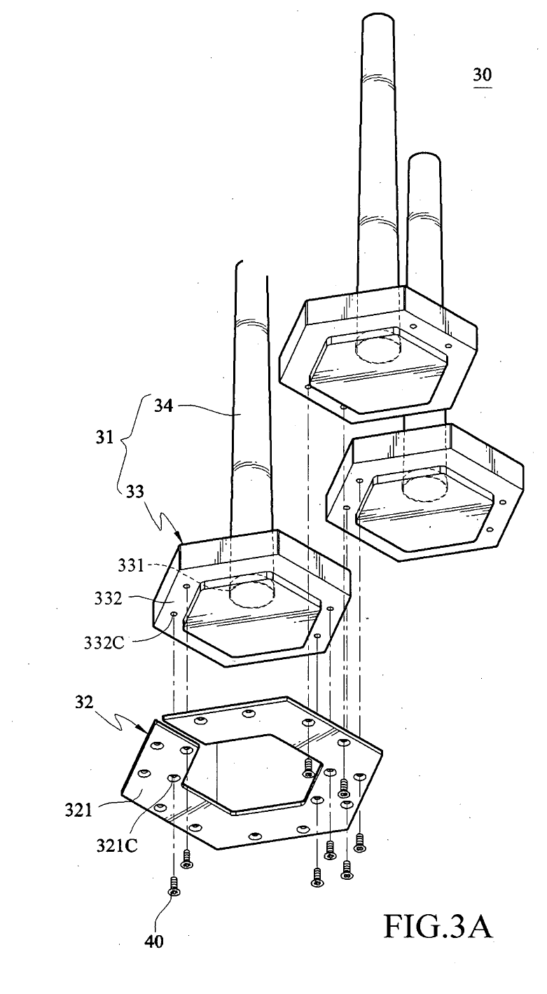

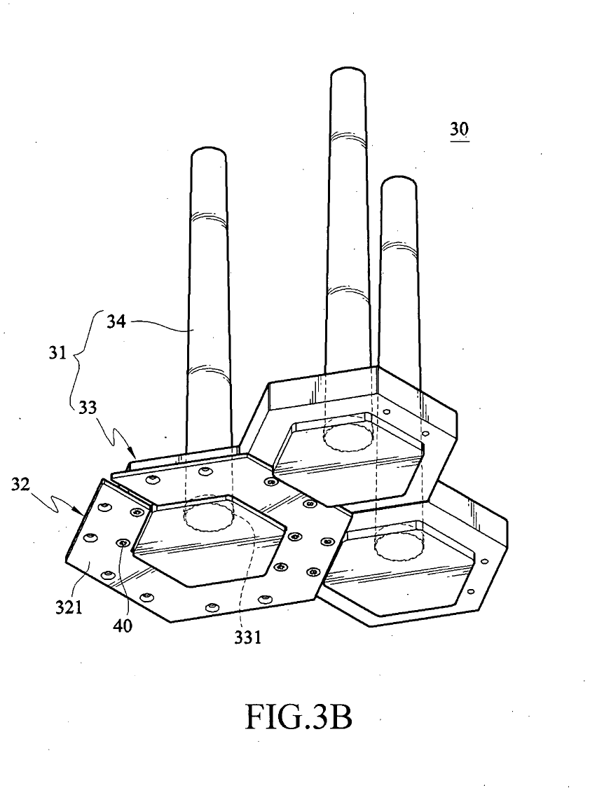

Referring to FIGS. 3A and 3B, an antenna assembly 30 according to the third embodiment of the present invention is shown, which also includes a plurality of wireless signal transceivers 31 and at least one positioning plate 32. The overall structure of the third embodiment is also similar to that of the first embodiment, while the difference lies in that the antenna assembly 30 further includes a plurality of fixing members 40. Furthermore, the positioning portion 321 and the fixing portion 332 further have bolt holes 321C and 332C respectively. Therefore, when attaching the fixing portion 332 of the base 33 towards the positioning portion 321 of the positioning plate 32, the fixing members 40 pass through the bolt holes 321C and 332C respectively, i.e., the fixing members 40 pass through the positioning portion 321 and are fixed to the fixing portion 332, so as to fix the base 33 to the positioning plate 32 (as shown in FIG. 3B). The fixing members 40 are screws, but are not limited to be screws.

As the projected area of each of the bases is slightly smaller than the area of the positioning plate, and the shape of the positioning plate is not limited to be the regular polygon of the first embodiment, but can be in different arranging configurations according to the requirements of the communication specifications. Therefore, an antenna assembly is further described as a fourth embodiment of the present invention.

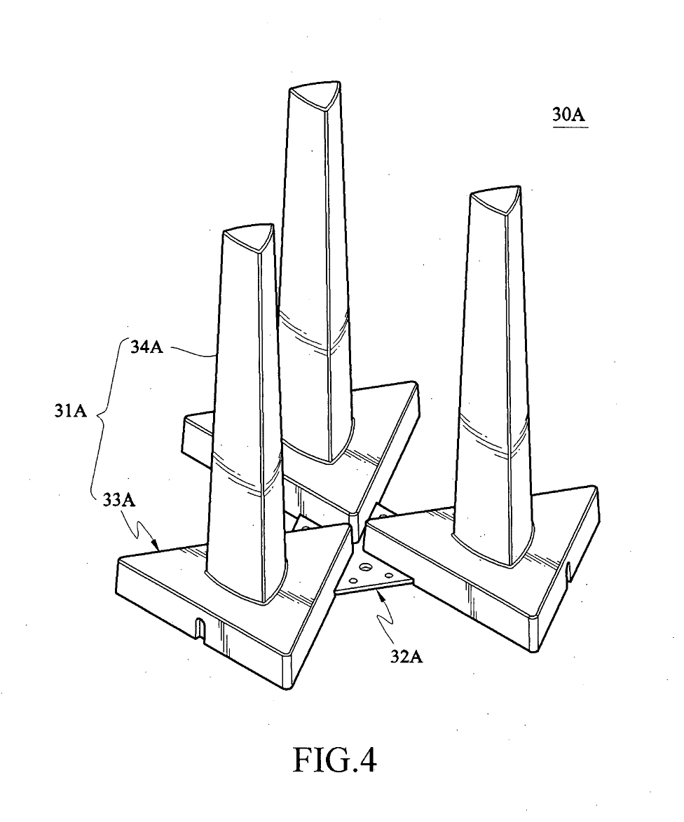

Referring to FIG. 4A, an antenna assembly 30A includes a plurality of wireless signal transceivers 31A and at least one positioning plate 32A. The structure and composition of the fourth embodiment is also similar to that of the first embodiment, while bases 33A are in a triangular shape, and do not contact one another, and the shape of the section of transmitting and receiving portions 34A is also different from the shape of the base 33A.

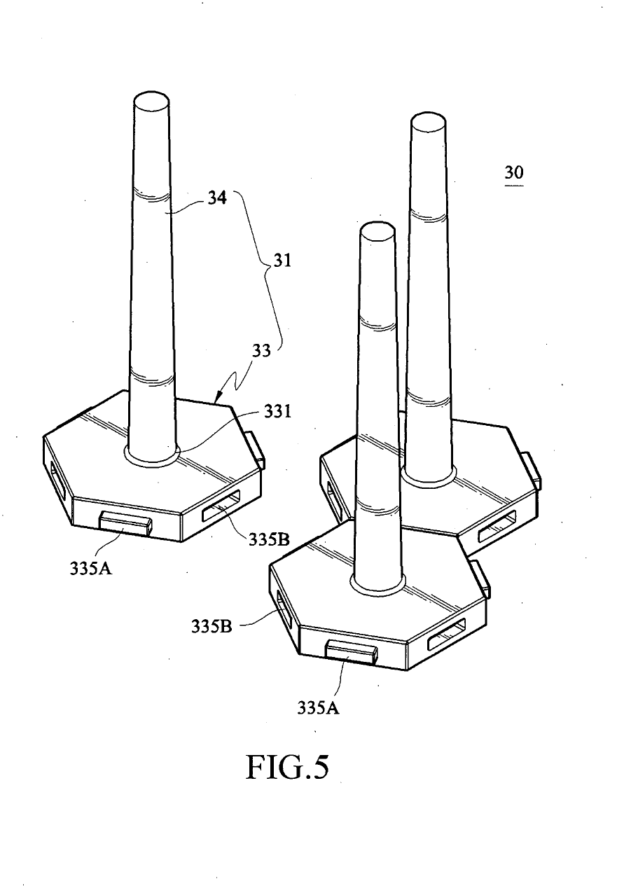

Referring to FIG. 5, an antenna assembly 30 according to a fifth embodiment of the present invention is shown, which includes a plurality of wireless signal transceivers 31 connected with one another. Each of the wireless signal transceivers 31 has a base 33 and a transmitting and receiving portion 34 disposed on the base 33. A first engaging portion 335A and a second engaging portion 335B matching with each other are arranged on sides of each of the bases 33. The first engaging portion 335A and the second engaging portion 335B are an engaging block and an engaged hole matching with each other. The first engaging portion 335A of a wireless signal transceiver 31 is engaged with the second engaging portion 335B of another wireless signal transceiver 31, so as to combine the two wireless signal transceivers 31. Thus, the antenna assembly 30 of this embodiment is formed by combining the plurality of wireless signal transceivers 31 sequentially.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An antenna assembly, comprising:
a plurality of wireless signal transceivers, each having a base and a transmitting and receiving portion disposed on the base; and
at least one positioning plate, for connecting each of the wireless signal transceivers, wherein the bases are fixed to the positioning plate.

2. The antenna assembly as claimed in claim 1, wherein each of the bases has a fixing hole, and one end of each of the transmitting and receiving portions is fixed in the fixing hole of the corresponding base.

3. The antenna assembly as claimed in claim 1, wherein the bases and the transmitting and receiving portions are formed monolithically.

4. The antenna assembly as claimed in claim 1, wherein the transmitting and receiving portions are disposed inside the bases.

5. The antenna assembly as claimed in claim 1, wherein each of the bases has a fixing portion, and the positioning plate has a positioning portion for each of the fixing portion being coupled to the positioning portion.

6. The antenna assembly as claimed in claim 5, wherein each of the fixing portions has a plurality of positioning holes, and the positioning portion has a plurality of positioning posts for being inserted into the positioning holes.

7. The antenna assembly as claimed in claim 5, wherein each of the fixing portions has a plurality of positioning posts, and the positioning portion has a plurality of corresponding positioning holes for the positioning posts to be inserted into.

8. The antenna assembly as claimed in claim 1, further comprising a plurality of fixing members passing through the positioning portion and fixed to each of the fixing portions.

9. The antenna assembly as claimed in claim 8, wherein the fixing members are screws.

10. An antenna assembly, comprising:
a plurality of wireless signal transceivers, each having a base and a transmitting and receiving portion disposed on the base, wherein a first engaging portion and a second engaging portion corresponding to each other are disposed at opposite sides of each of the bases, so as to connect the bases.

11. The antenna assembly as claimed in claim 10, wherein each of the bases has a fixing hole, and one end of each of the transmitting and receiving portions is fixed in the fixing hole.

12. The antenna assembly as claimed in claim 10, wherein the bases and the transmitting and receiving portions are formed monolithically.

13. The antenna assembly as claimed in claim 10, wherein the transmitting and receiving portions are disposed inside the bases.

14. The antenna assembly as claimed in claim 10, wherein each of the first engaging portions and each of the second engaging portions are an engaging block and a corresponding engaged hole respectively.
